(19) United States
(12) Patent Application Publication
(10) Pub. No.: US 2013/0003013 A1
(43) Pub. Date: Jan. 3, 2013

(54) Interchangeable Eyewear

(76) Inventors: Brittnay COLLINS, Pompano Beach, FL (US); Robert COLLINS, Pompano Beach, FL (US)

(21) Appl. No.: 13/420,408

(22) Filed: Mar. 14, 2012

Related U.S. Application Data
(60) Provisional application No. 61/501,867, filed on Jun. 28, 2011.

(51) Int. Cl. G02C 5/14

(52) U.S. Cl. 351/116

(57) ABSTRACT

An interchangeable eyewear with an interchangeable temple and an quick release connector. The present invention comprises a quick release connector and an interchangeable temple. The quick release connector comprises a hinge end and a central aperture. The central aperture comprises a plurality of female bored cylinders, which are to be attached to a plurality of ball plungers connected to a male end of the interchangeable temple. The plurality of ball plungers are positioned within a plurality of male bored cylinders on the male end. The attachment of the interchangeable temple to the quick release connector is made possible by the engagement of the plurality of ball plungers to the plurality of female bored cylinders. The plurality of springs and the plurality of balls within the plurality of ball plungers allow the plurality of ball plungers to slide in and snap into the central aperture of the quick release connector.

The current application claims a priority to the U.S. Provisional Patent application Ser. No. 61/501,867 filed on Jun. 28, 2011.

### FIELD OF THE INVENTION

The present invention relates generally to an apparatus for eyewear. More specifically, the present invention is eyewear with interchangeable temples that utilizes a simple quick release connector assembly.

### BACKGROUND OF THE INVENTION

Eyewear is worn to correct visual defects or to protect the eyes from the sun. Currently, most eyewear consists of a pair of lenses supported by a frame, which is attached to a pair of temples with a hinge. The hinge forms a joint, where one part is attached to the frame and the other part is attached to the temple, and a screw connects the joint to form a hinge. However, with this design a tool is required, and it is difficult as well as time consuming if a user desires to change the temples himself.

It is therefore an object of the present invention is to provide a simple quick release connector assembly to quickly and easily change the temples for optical or sunshade eyewear. The interchangeability of the temples is desirable if the user requires temples of different designs or colors. The temples are attached and detached by a simple hand action.

The present invention will become apparent from the following detailed description taken in conjunction with the accompanying drawing figures in which like reference numerals designate like or corresponding parts throughout the figures.

### BRIEF DESCRIPTION OF THE DRAWINGS

FIG. 1 is a perspective view of the present invention.

FIG. 2 is a perspective view of the quick release connector.

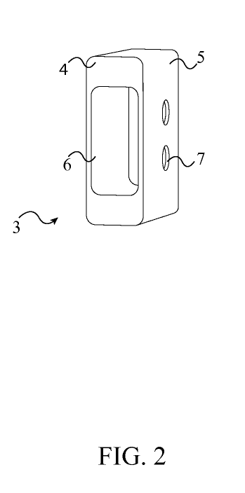

FIG. 3 is a side view of the interchangeable temple with the male bored cylinders.

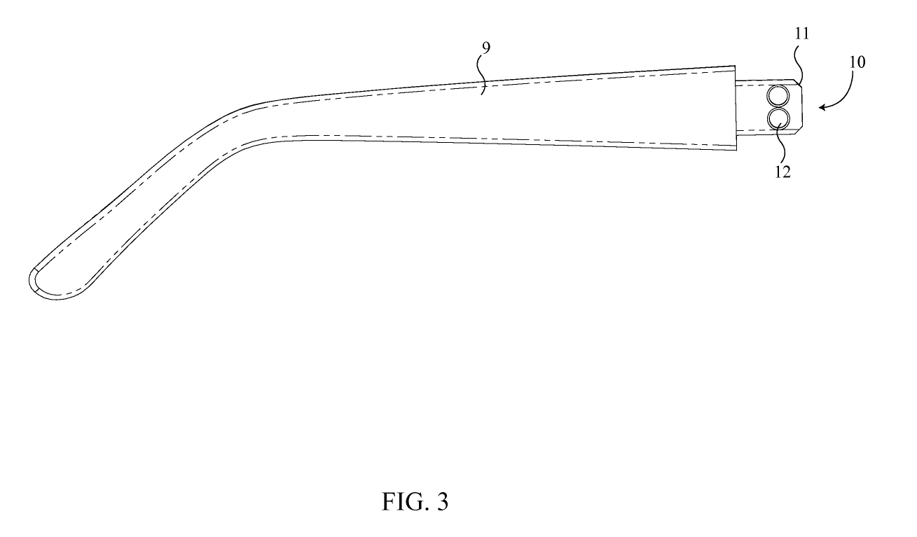

FIG. 4 is a side view of the interchangeable temple with the ball plungers attached to the male bored cylinders.

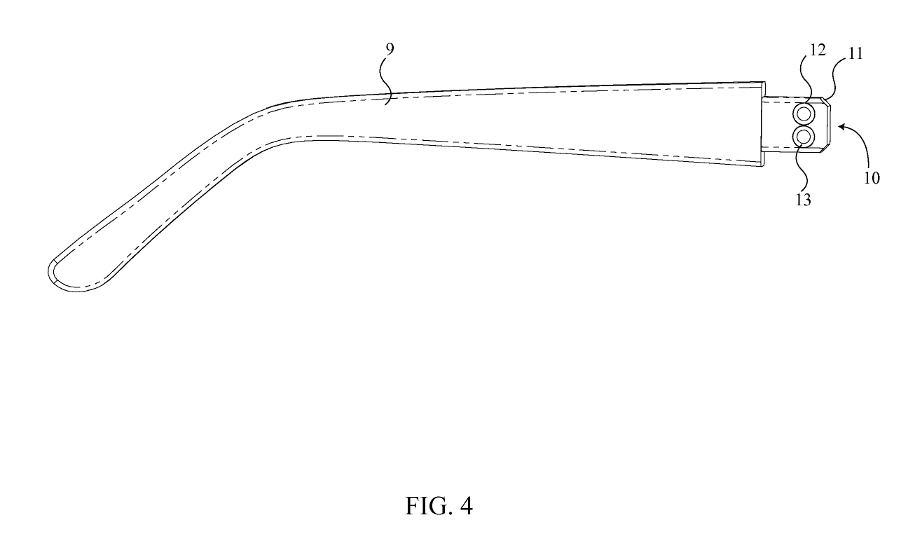

FIG. 5 is a front view of the interchangeable temple with ball plungers attached.

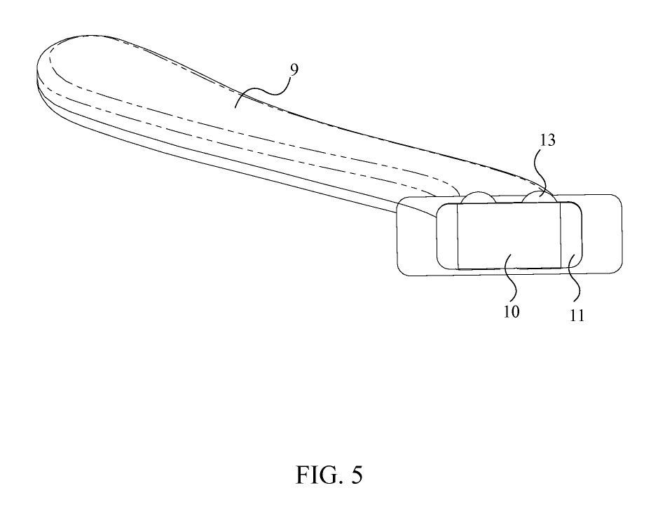

FIG. 6 is a cross-sectional view of the ball plungers within the interchangeable temple.

### DETAILED DESCRIPTION OF THE INVENTION

All illustrations of the drawings are for the purpose of describing selected versions of the present invention and are not intended to limit the scope of the present invention.

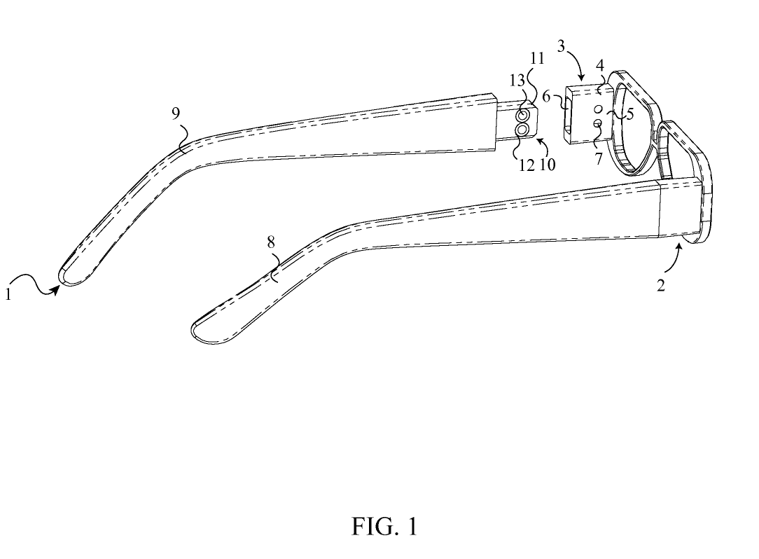

The present invention is an interchangeable eyewear 1 that comprises a left quick release connector 2, a right quick release connector 3, a left interchangeable temple 8, and a right interchangeable temple 9 as can be seen in FIG. 1. The present invention allows temples of an eyeglass frame to be easily replaced. The present invention has been designed to fit to each temple of the eyeglass frame. The left interchangeable temple 8 and the right interchangeable temple 9 may be of various colors and designs. The left interchangeable temple 8 and the right interchangeable temple 9 each has a male end 10 with a plurality of male bored cylinders 12 and a plurality of ball plungers 13. The plurality of ball plungers 13 is positioned within the plurality of male bored cylinders 12. The diameter of each of the plurality of male bored cylinders 12 is designed to fit around the outside diameter of each of the plurality of the ball plungers 9. Moreover, the plurality of ball plungers 13 is positioned laterally on the male end 10 of both the left interchangeable temple 8 and the right interchangeable temple 9. In the preferred embodiment, the plurality of ball plungers 13 are positioned parallel to each other, but it is understood that the plurality of ball plungers 13 may be positioned in any configuration in the present invention. The configuration of the plurality of the ball plungers 9 may be circular, rectangular, polygonal, or random. It is also understood that the plurality of ball plungers 13 may be positioned on both lateral sides of the male end 10.

The male end 10 is to be mated with a central aperture 6. The central aperture 6 serves as the female connector for the male end 10 to fit into. The central aperture 6 has a plurality of female bored cylinders 7, where the plurality of ball plungers 13 may fit into. In this manner, the left interchangeable temple 8 and the right interchangeable temple 9 are respectively engaged to the left quick release connector 2 and the right quick release connector 3. The left quick release connector 2 and the right quick release connector 3 each has a connector body 4, a hinge end 5, and a central aperture 6. The central aperture 6 is positioned within the connector body 4. The plurality of female bored cylinders 7 is positioned laterally on the connector body 4. The plurality of female bored cylinders 7 traverses through the connector body 4. The position of the plurality of female bored cylinders 7 is in alignment with the plurality of the male bored cylinders 8 and the plurality of ball plungers 13 of the male end 10. As one end of the connector body 4 is attached to the male end 10, the other end of the connector body 4 is attached to the side of the eyeglass frame via the hinge end 5. Therefore, the hinge end 5 forms a joint between the left quick release connector 2 and the left side of the eyeglass frame and forms a joint between the right quick release connector 3 and the right side of the eyeglass frame. The hinge end 5 allows the left quick release connector 2 and the right quick release connector 3 to be rotatably attached to the eyeglass frame. While one end of the connector body 4 forms the hinge end 5, the opposing end of the connector body 4 has the male end 10 attached via the central aperture 6. The central aperture 6 is dimensioned to mate with the male end 10. The left quick release connector 2 along with the left interchangeable temple 8 is a minor image of the right quick release connector 3 along with the right interchangeable temple 9.

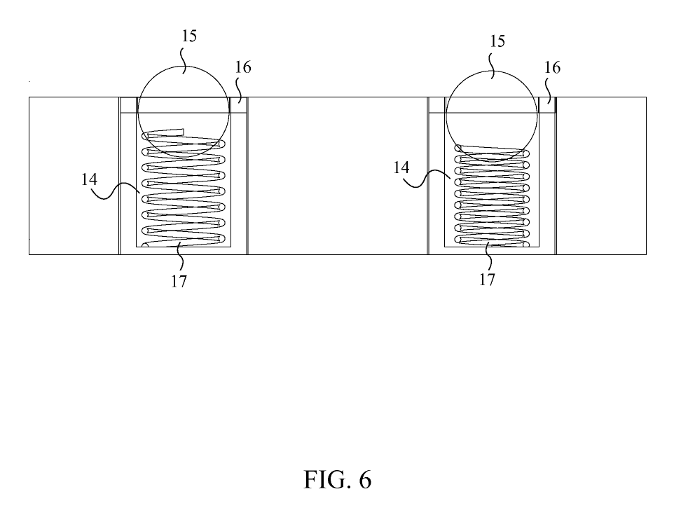

The plurality of ball plungers 13 is fixed within the male end 10 via the plurality of male bored cylinders 12. The base of the plurality of ball plungers 13 is flush with the surface of the male end 10. The top of each of the plurality of ball plungers 13 is a stopper flange 16, which is flush with the other surface of the male end 10. As can be seen in FIG. 6, the plurality of ball plungers 13 is viewed in a cross-sectional manner. The plurality of ball plungers 13 is positioned concentrically within the plurality of male bored cylinders 12 so both the top and the base of each of the plurality of ball plungers 13 are flush with the lateral surfaces of the male end 10. The plurality of ball plungers 13 is fixed mounted within the abutment of the male end 10. The perimeter of the abutment outer face is preferably sloped or beveled to facilitate receipt thereof into the central aperture 6. In the preferred embodiment, both the male end 10 and the central aperture 6 have a rectangular cross-section. It is understood that in the present invention, the cross-section of both the male end 10 and the central aperture 6 may be of various shapes such as those of a circle or a polygon. As can be seen in FIG. 6, each of the plurality of ball plungers 13 comprises a spring hole 14, a ball 15, a spring 17, and a stopper flange 16. The stopper flange 16 is situated atop the spring 17. The stopper flange 16 serves as a stop to limit the ball 15 from exiting the spring hole 14 and consequently from each of the plurality of ball plungers 13. Another function of the stopper flange 16 is to confine the ball 15 within the spring hole 14 of each of the plurality of ball plungers 13. Therefore, when pressure is applied to the ball 15, the ball 15 will move vertically up and down in alignment with the spring 17, the spring hole 14 and the stopper flange 16. The spring 17 is positioned inside each of the plurality of ball plungers 13. The ball 15 is situated atop the spring 17. Atop the spring 17 is the stopper flange 16, which is flush with the side surface of the male end 10. The protrusion of the ball 15 above the spring hole 14 is limited by the stopper flange 16, which encircles the ball 15 and stops the ball 15 from falling out of the spring hole 14 and consequently from the plurality of ball plungers 13. The spring 17 allows the ball 15 to be easily pressed down to snap the plurality of ball plungers 13 into the plurality of female bored cylinders 7 located on the central aperture 6. The spring 17 also allows the position of the ball 15 to be adjustable and in alignment with the plurality of female bored cylinders 7 of the central aperture 6. The diameter of each of the plurality of the female bored cylinders 7 has been dimensioned to fit around the diameter of the ball in each of the plurality of the ball plungers 9.

FIG. 6 illustrates the side elevation view of the plurality of ball plungers 13 within the male end 10 of the left interchangeable temple 8 and right interchangeable temple 9. Each of the plurality of ball plungers 13 is typically a stainless steel sphere that slides within each of the plurality of male bored cylinders 12 against the pressure of the spring 17 within each of the plurality of ball plungers 13. The spring 17 maintains a constant upward pressure on the ball 15 within each of the plurality of ball plungers 13. The plurality of ball plungers 13 are retained within the plurality of male bored cylinders 12 by a constriction. The plurality of male bored cylinders 12 are dimensioned to hold the plurality of ball plungers 13 within the plurality of male bored cylinders 12.

Although a plurality of ball plungers 13 has been described for the purposes of this disclosure, it will be understood by those skilled in the art that generally any spring-loaded push button or other type of actuation mechanism could alternatively be used in the present invention.

When the user wants to mount the male end 10 to the central aperture 6, the user applies force by pushing the male end 10 into the central aperture 6. The male end 10 has a plurality of bevels 11, which facilitates the insertion of the male end 10 into the central aperture 6. During this insertion, the walls of the central aperture 6 force the ball 15 within each of the plurality of ball plungers 13 into each of the plurality of female bored cylinders 7, which are positioned on each of the left quick release connector 2 and the right quick release connector 3 until the plurality of ball plungers 13 are aligned directly with the plurality of female bored cylinders 7. Then, the upwardly constant force of the spring 17 within each of the plurality of ball plungers 13 forces the ball 15 within each of the plurality of ball plungers 13 to snap into each of the plurality of female bored cylinders 7 and hold the connector body 4 in position. The plurality of ball plungers 13 will not release from the engagement with the plurality of female bored cylinders 7 until additional force is applied.

To detach the left interchangeable temple 8 or the right interchangeable temple 9, the user applies a separating force with a simple hand motion by pulling the left interchangeable temple 8 or the right interchangeable temple 9 in one direction and by pulling the left quick release connector 2 or the right quick release connector 3 in the opposite direction. This removes the male end 10 from the central aperture 6. This separating force causes the engagement ledge of the central aperture 6 to push the ball 15 within each of the plurality of ball plungers 13 further into the spring hole 14, which compresses the spring 17 within each of the plurality of ball plungers 13. This causes the ball 15 within each the plurality of ball plungers 13 to subsequently fall below the walls of the central aperture 6 allowing the male end 10 to be removed.

Although the invention has been explained in relation to its preferred embodiment, it is to be understood that many other possible modifications and variations can be made without departing from the spirit and scope of the invention as hereinafter claimed.

What is claimed is:

1. An interchangeable eyewear comprises:
a left quick release connector;
a right quick release connector;
a left interchangeable temple;
a right interchangeable temple;
an eyeglass frame;
the left quick release connector and the right quick release connector each comprise a connector body, a hinge end, and a central aperture;
the left interchangeable temple and the right interchangeable temple each comprise a male end;
the central aperture comprises a plurality of female bored cylinders;
the male end comprises a plurality of male bored cylinders and a plurality of ball plungers;
each of the plurality of ball plungers comprises a spring hole, a ball, a spring, and a stopper flange;

2. The interchangeable eyewear as claimed in claim 1 comprises,
the left quick release connector being attached to the left interchangeable temple;
the right quick release connector being attached to the right interchangeable temple;
the left quick release connector being rotatably attached to the eyeglass frame;
the right quick release connector being rotatably attached to the eyeglass frame opposite of the left quick release connector;
the male end being engaged in the central aperture; and
the central aperture being positioned within the connector body.

3. The interchangeable eyewear as claimed in claim 2 comprises,
the hinge end of the left quick release connector being rotatably attached to the eyeglass frame;
the hinge end of the right quick release connector being rotatably attached to the eyeglass frame;
the male end of the left interchangeable temple being attached to the left quick release connector;
the male end of the right interchangeable temple being attached to the right quick release connector; and
the plurality of bevels being located on the male end.

4. The interchangeable eyewear as claimed in claim 1 comprises,
the plurality of male bored cylinders traversing into the male end;
the plurality of female bored cylinders traversing into the central aperture;
the plurality of male bored cylinders being laterally positioned on the male end; and
the plurality of female bored cylinders being laterally positioned within the central aperture.

5. The interchangeable eyewear as claimed in claim 4 comprises,
the plurality of ball plungers being concentrically connected within the plurality of male bored cylinders; and
the plurality of female bored cylinders being engaged by the plurality of ball plungers.

6. The interchangeable eyewear as claimed in claim 5 comprises,
the ball being positioned inside the spring hole;
the spring being positioned inside the spring hole; and
the stopper flange being positioned inside the spring hole.

7. The interchangeable eyewear as claimed in claim 6 comprises,
the ball being situated atop the spring;
the spring being aligned with the spring hole;
the stopper flange being positioned above the spring; and
the stopper flange being positioned concentrically around the ball.

8. An interchangeable eyewear comprises:
a left quick release connector;
a right quick release connector;
a left interchangeable temple;
a right interchangeable temple;
an eyeglass frame;
the left quick release connector and the right quick release connector each comprise a connector body, a hinge end, and a central aperture;
the left interchangeable temple and the right interchangeable temple each comprise a male end;
the central aperture comprises a plurality of female bored cylinders;
the male end comprises a plurality of male bored cylinders and a plurality of ball plungers;
each of the plurality of ball plungers comprises a spring hole, a ball, a spring, and a stopper flange;
the left quick release connector being attached to the left interchangeable temple;
the right quick release connector being attached to the right interchangeable temple;
the left quick release connector being rotatably attached to the eyeglass frame;
the right quick release connector being rotatably attached to the eyeglass frame opposite of the left quick release connector;
the male end being engaged in the central aperture; and
the central aperture being positioned within the connector body.

9. The interchangeable eyewear as claimed in claim 8 comprises,
the hinge end of the left quick release connector being rotatably attached to the eyeglass frame;
the hinge end of the right quick release connector being rotatably attached to the eyeglass frame;
the male end of the left interchangeable temple being attached to the left quick release connector;
the male end of the right interchangeable temple being attached to the right quick release connector; and
the plurality of bevels being located on the male end.

10. The interchangeable eyewear as claimed in claim 8 comprises,
the plurality of male bored cylinders traversing into the male end;
the plurality of female bored cylinders traversing into the central aperture;
the plurality of male bored cylinders being laterally positioned on the male end;
the plurality of female bored cylinders being laterally positioned within the central aperture;
the plurality of ball plungers being concentrically connected within the plurality of male bored cylinders; and
the plurality of female bored cylinders being engaged by the plurality of ball plungers.

11. The interchangeable eyewear as claimed in claim 10 comprises,
the ball being positioned inside the spring hole;
the spring being positioned inside the spring hole;
the stopper flange being positioned inside the spring hole;
the ball being situated atop the spring;
the spring being aligned with the spring hole;
the stopper flange being positioned above the spring; and
the stopper flange being positioned concentrically around the ball.

12. An interchangeable eyewear comprises:
a left quick release connector;
a right quick release connector;
a left interchangeable temple;
a right interchangeable temple;
an eyeglass frame;
the left quick release connector and the right quick release connector each comprise a connector body, a hinge end, and a central aperture;
the left interchangeable temple and the right interchangeable temple each comprise a male end;
the central aperture comprises a plurality of female bored cylinders;
the male end comprises a plurality of male bored cylinders and a plurality of ball plungers;
each of the plurality of ball plungers comprises a spring hole, a ball, a spring, and a stopper flange;
the left quick release connector being attached to the left interchangeable temple;
the right quick release connector being attached to the right interchangeable temple;
the left quick release connector being rotatably attached to the eyeglass frame;
the right quick release connector being rotatably attached to the eyeglass frame opposite of the left quick release connector;
the male end being engaged in the central aperture;
the central aperture being positioned within the connector body;
the hinge end of the left quick release connector being rotatably attached to the eyeglass frame;
the hinge end of the right quick release connector being rotatably attached to the eyeglass frame;
the male end of the left interchangeable temple being attached to the left quick release connector;
the male end of the right interchangeable temple being attached to the right quick release connector; and
the plurality of bevels being located on the male end.

13. The interchangeable eyewear as claimed in claim 12 comprises,
the plurality of male bored cylinders traversing into the male end;
the plurality of female bored cylinders traversing into the central aperture;
the plurality of male bored cylinders being laterally positioned on the male end; and
the plurality of female bored cylinders being laterally positioned within the central aperture.

14. The interchangeable eyewear as claimed in claim 13 comprises,
the plurality of ball plungers being concentrically connected within the plurality of male bored cylinders;
the plurality of female bored cylinders being engaged by the plurality of ball plungers;
the ball being positioned inside the spring hole;
the spring being positioned inside the spring hole;
the stopper flange being positioned inside the spring hole;
the ball being situated atop the spring; and
the spring being aligned with the spring hole.

15. The interchangeable eyewear as claimed in claim 14 comprises,
the stopper flange being positioned above the spring; and
the stopper flange being positioned concentrically around the ball.
